(19) United States
(12) Patent Application Publication
(10) Pub. No.: US 2025/0080957 A1
(43) Pub. Date: Mar. 6, 2025

(54) SYSTEM FOR COLLECTING AND SYNCHRONIZING DATA FROM WIRELESS WEARABLE SENSORS AND METHOD FOR SYNCHRONIZING DATA FROM WIRELESS WEARABLE SENSORS

(71) Applicant: Vilnius Gediminas Technical University, Vilnius (LT)

(72) Inventors: Arturas Serackis, Vilnius (LT); Julius Griškevicius, Vilnius (LT); Andžela Šešok, Vilnius (LT); Rytis Maskeliunas, Radikiu km., Domeikavos sen., Kauno raj. (LT); Darius Plonis, Vilnius (LT); Vytautas Abromavicius, Vilnius (LT)

(21) Appl. No.: 18/458,449

(22) Filed: Aug. 30, 2023

(51) Int. Cl. H04W 4/38; H04L 67/1095

(52) U.S. Cl. CPC H04W 4/38; H04L 67/1095

(57) ABSTRACT

The present invention relates to a system and method for collecting and analysing data from wearable sensors. The system comprises: wearable wireless multi-component devices designed to monitor various physiological and environmental parameters; a data collection hub responsible for gathering data from the wearable sensors; and a cloud-based signal analysis algorithm tailored for data interpretation. The salient feature of this invention lies in its ability to autonomously synchronize multiple wearable wireless multi-component devices comprising sensors without the need to send explicit synchronization signals from the data collection hub. This innovative synchronization method is made possible through the implementation of a modified communication protocol, in conjunction with sophisticated data analysis techniques. Such an approach not only simplifies the data collection process but also enhances the efficiency and reliability of the system as a whole. The invention offers substantial benefits in various applications, especially in real-time health monitoring and environmental tracking scenarios.

### FIELD OF THE INVENTION

The invention relates to a system for collecting and synchronizing data from wearable wireless multi-component devices comprising sensors and method for synchronizing data from such devices, specifically, the invention pertains to the seamless and efficient collection and synchronization of data from various sensors operating at different sampling frequencies.

### BACKGROUND OF THE INVENTION

The proliferation of wearable technology has revolutionized various fields, from health and wellness monitoring to sports analytics and personal fitness tracking. Central to this innovation has been the development of wearable wireless multi-component devices comprising sensors, tailored to track an array of parameters including physiological signals and motion data.

Prior art has often combined these wearable wireless multi-component devices with data hubs, which gather, store, and sometimes process the data. Such systems typically rely on wireless communication protocols, such as Bluetooth, Zigbee, or Wi-Fi, to transfer data. To ensure data integrity and coherence, especially in systems with multiple sensors, synchronization becomes imperative. Previous solutions have necessitated explicit synchronization signals dispatched from the data collection hubs. This approach, while functional, introduces additional complexities and often compromises the system's efficiency.

Furthermore, existing systems predominantly operate on a single or a limited range of sampling frequencies, which might be restrictive for applications requiring diverse data types, such as medical signal and motion tracking simultaneously.

On the data analysis front, cloud-based processing has emerged as a viable strategy. Prior systems have utilized cloud platforms mainly for storage and basic analytics. However, deeper, more nuanced analyses, particularly involving pattern matching for motion data synchronization, have been sparse in traditional setups.

The intention to monitor patients undergoing rehabilitation procedures from the comfort of their homes is not novel. Yet, most existing systems either focus solely on medical signal tracking or on motion tracking, but seldom both. Moreover, they often fall short in terms of real-time feedback, due to limitations in data processing speed or the lack of intuitive access points like APIs for external systems or professionals to review and interpret data.

U.S. Pat. No. 11,164,596 discloses a system for evaluating health-related quality of life (HRQOL). The system comprises a sensor adapted to generate sensor data for a user, a memory adapted to store the sensor data, and a processor coupled to the sensor and the memory. The processor can be configured to initiate executable operations including determining a first biological marker for the user from the sensor data, wherein the first biological marker is indicative of a first dimension of HRQOL, performing speech analysis on user provided speech to determine a second biological marker indicative of a second dimension of HRQOL. The processor is further configured to initiate executable operations including comparing the first biological marker and the second biological marker with a baseline for the first biological marker and a baseline for the second biological marker, respectively, and outputting a result of the comparing.

Publication Assad Uz Zaman, M., Islam, M. R., Rahman, M. H. et al. Robot sensor system for supervised rehabilitation with real-time feedback. Multimed Tools Appl 79, 26643-26660 (2020) discloses a humanoid robot, NAO, and rehabilitation exercises with NAO, a library of recommended rehabilitation exercises involving the shoulder (abduction/adduction, vertical flexion/extension, and internal/external rotation), and elbow (flexion/extension) joint movements were created. An Xbox Kinect sensor was used to analyze the subject upper arm movement during rehabilitation. For this purpose, a complete geometric solution was developed to find a unique inverse kinematic solution of human upper-arm from the Kinect data. A control algorithm was developed in MATLAB for the proposed robot guided supervised rehabilitation protocol. Experimental results show that the NAO and Kinect sensor can effectively be used to supervise and guide the subjects in performing active rehabilitation exercises for the shoulder and elbow joint movements.

A U.S. patent application Ser. No. 16/858,320 discloses a semiconductor device. The semiconductor device comprises a first terminal receiving a first signal, a second terminal receiving a second signal, a noise extraction analysis unit extracting a signal of a specific frequency component from the first and the second signal, a feedback unit generating a feedback signal based on a magnitude of the signal of the specific frequency component to cancel the signal of the specific frequency component superimposed on the first and the second signal, and third terminal outputting to the feedback signal to outside.

While the landscape of wearable technology and associated data processing techniques has seen commendable advancements, gaps remain, especially in the realms of autonomous sensor synchronization, simultaneous multi-parameter tracking, and refined cloud-based data analytics. This invention aims to address these very gaps, building upon the foundations laid by prior art but introducing novel functionalities that promise enhanced efficiency and broader applicability.

### SUMMARY OF THE INVENTION

The system for collecting and synchronizing data from wearable wireless multi-component device comprising sensors and the method for synchronizing data from such devices according to the invention autonomously synchronize and analyse data collected from multiple sensors.

The system comprises wearable wireless multi-component devices, a data collection hub. The method comprises use of modified communication protocol, cloud-based analysis, and API access.

The wearable wireless multi-component devices are tailored to capture an array of data types. They include sensors for recording intricate medical signals and those dedicated to registering motion. Each type operates at a distinct sampling frequency optimized for the specific data it captures.

A data collection hub, serving as a central data collection point being either an embedded system or a computer device, receives data from multiple sensors simultaneously, accommodating anywhere between 8 to 32 sensors, ensuring seamless assimilation of data from diverse sources without the loss of fidelity.

The modified communication protocol integrates additional synchronization information directly into data packet headers, eliminating the need for external synchronization signals, thereby enhancing the system's efficiency and robustness.

Once the data is collected, it's relayed to a cloud-based platform for detailed analysis. Here, advanced algorithms interpret the sensor signals, with special emphasis on motion data synchronization via pattern matching techniques. This ensures the precision and accuracy of motion tracking, which is pivotal for users undergoing rehabilitation or participating in motion-centric activities.

Post-analysis, the processed data can be accessed and reviewed via an API interface. This provides flexibility and convenience, allowing both end-users and third-party platforms to interpret the data, facilitating its integration into other systems or applications.

The invention's primary intent is to cater to patients undergoing home-based rehabilitation, ensuring adherence to prescribed movement patterns and techniques. However, its versatile design also makes it suitable for other users, such as those committed to physical workouts or children engaged in motion-dependent games.

### BRIEF DESCRIPTION OF THE DRAWINGS

The accompanying drawings illustrate embodiments of the invention and, together with the description, serve to explain the principles of the present invention.

FIG. 1 shows architecture of the system, according to the invention, showcasing the connection between the wearable wireless multi-component devices (102) freely mounted on a human body (103), the data collection hub (101), and the cloud-based analysis mechanism (104).

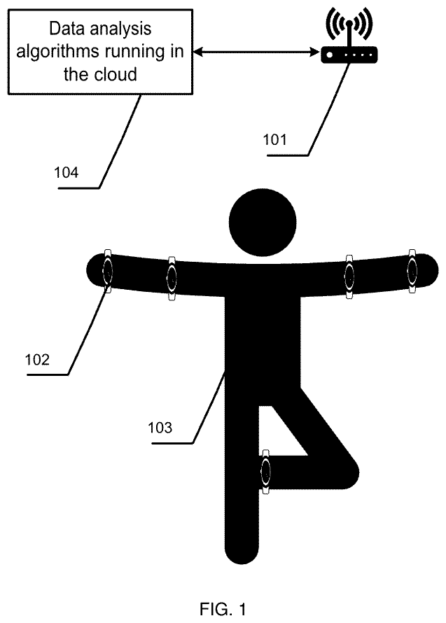

FIG. 2 shows a detailed view of a wearable wireless multi-component devices, highlighting its structural design, sensor elements, and wireless communication components. This figure further illustrates the various types of sensors, distinguishing between those for medical signal detection and motion sensors.

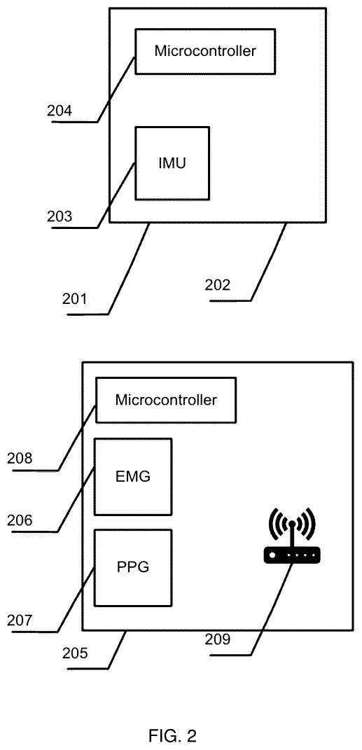

FIG. 3 depicts the workflow of data collection and synchronization according to the invention. This figure emphasizes the sequence in which data is gathered, sent to the hub, and the subsequent transfer to the cloud. The unique aspect of the modified communication protocol with the synchronization-relevant information embedded in the data packet headers is also showcased here.

FIG. 4 provides an expanded view of the data collection hub, detailing its interfaces for receiving data from multiple sensors, its processing core, and communication link to the cloud.

FIG. 5 showcases the cloud-based analysis system, with a focus on the algorithms used for analysing sensor signals, the pattern matching techniques, and the final output or report generation mechanism.

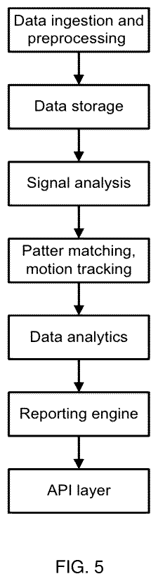

FIG. 6 illustrates the user interface provided to patients and other users, including how they can access, view, and interpret data, especially leveraging the API.

FIG. 7 demonstrates the process of automatic synchronization of wearable wireless multi-component devices in real-time scenarios, highlighting the role of the modified communication protocol and the absence of explicit synchronization signals from the data collection hub.

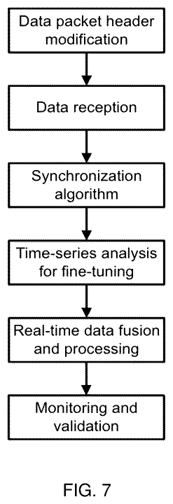

FIG. 8 provides a flowchart representation of the entire data collection, synchronization, and analysis process, beginning from the moment data is captured by the wearable wireless multi-component devices to the point where processed data is accessed by end users.

### DETAILED DESCRIPTION OF THE INVENTION

While the invention has been described in generic terms above, this section delves into specific embodiments that illustrate how the system and method can be implemented in practice. This detailed description, along with accompanying drawings, provides a clearer understanding of the inventive concepts.

The system for collecting and synchronizing data from wireless wearable multi-component devices according to the invention comprises:
multiple wearable wireless multi-component devices comprising sensors for recording medical signals or motion. The wearable wireless multi-component devices with motion sensors employ advanced pattern matching techniques, facilitating the precise tracking of user movements, pivotal for activities like rehabilitation exercises, workouts, and children's play-centric motion games;
a data collection hub for receiving data from said sensors. The data collection hub is an embedded system or a computer device. The data collection hub is adapted for simultaneously receiving data from a multitude of multiple wearable wireless multi-component devices, in total ranging between 8 to 32 sensors. In one instance the data collection hub can be a portable embedded system with a design emphasis on power efficiency and real-time processing, utilising a multi-channel architecture to simultaneously receive data from multiple sensors. In another instance the data collection hub can be a computer device, such as a general-purpose computer for running software, leveraging its processing power and larger storage capabilities. The data collection hub serves as the central node in the system, responsible for receiving, processing, and forwarding data from multiple wearable wireless multi-component devices to the cloud-based analytics platform. The hub is designed to work efficiently, securely, and robustly, handling data from multiple sources simultaneously in IoT;
a cloud-based signal processing platform for analysing said data. The data resulting from multiple wearable wireless multi-component devices is subsequently channeled to the cloud, where algorithms analyse the sensor signals. The cloud-processed data can be reached via an API interface. The API is provided to allow third-party platforms or authorized personnel to access the processed data and analytics results. End-users like medical professionals or individuals can review the processed data and insights via a user-friendly dashboard accessible via web or mobile apps;
a modified communication protocol which integrates synchronization information into the header of data packets without the need for explicit synchronization signals. The modified communication protocol is built upon a foundational pre-existing protocol Bluetooth Low Energy (BLE), integrating additional synchronization-relevant information into the header of data packets. This alteration aids in the autonomous synchronization of the wearable wireless multi-component devices without demanding synchronization signals from an external source. Adding synchronization data in the header comprises designating specific bits within existing BLE packet headers or extending header lengths to accommodate new information.

The sensors of the wireless wearable multi-component devices can be such as sensors dedicated to capturing medical signals. This can be in the form of an ECG (electrocardiogram) patch adhered to a chest region of a person, capturing real-time heart electrical activity. The sensor could utilize a sampling frequency of, for instance, 500 Hz, ensuring high-fidelity capture of medical-grade signals. Battery optimization techniques, such as low-power modes during periods of inactivity, can be incorporated.

The sensors of the wireless wearable multi-component devices can be such as motion sensors, which may be in the form of accelerometers and gyroscopes embedded into wearable bands. Designed for placement on limbs, these sensors can track three-dimensional movement, making them particularly useful for rehabilitation exercises. Their operation could range across different sampling frequencies, from 50 Hz for gross movements up to 200 Hz for finer, intricate motions.

In all cases of the invention the wearable wireless multi-component devices comprises a casing made of lightweight, biocompatible materials such as medical-grade plastic or silicone.

As an example, the wearable wireless multi-component device (201) designed to capture motion data comprises: at least one sensor; an outer casing made of preferably hypoallergenic materials like medical-grade silicone or polyurethane to minimize irritation during extended use; a strap adjustable to fit various wrist or limb sizes and is designed for secure but comfortable fastening; internal electronics comprising inertial measurement unit—IMU (203), which utilizes MEMS (Micro-Electro-Mechanical Systems) technology for high sensitivity and low power consumption. The IMU (203) comprises one or combination of any of: an accelerometer, for measuring linear acceleration along the X, Y, and Z axes; a gyroscope, for measuring angular velocity and often complementing the accelerometer's data to provide a more complete picture of motion; a magnetometer for measuring magnetic fields, which can help in determining orientation relative to the Earth's magnetic field. The wearable wireless multi-component device (201) with IMU (203) preferably comprises a microcontroller (204), responsible for data acquisition, initial processing, and preparation for transmission. The microcontroller (204) also manages power usage, ensuring optimal battery life. The wearable wireless multi-component device (201) further comprises a wireless communication chip which transmits the processed data to the data collection hub. The wireless communication chip is based on Bluetooth Low Energy (BLE), modified as per the specialized communication protocol to include synchronization data within the header of data packets. The wearable multi-component device (201) further comprises a compact, embedded antenna integrated as a thin, flexible layer within the casing or strap and designed for effective short-range communication with minimal power consumption.

As another example, the wearable wireless multi-component device (205) comprises an electromyography sensor (206) and optionally a photoplethysmogram sensor (207). The wearable wireless multi-component device (205) preferably comprises a microcontroller (208), responsible for data acquisition, initial processing, and preparation for transmission. The microcontroller (208) also manages power usage, ensuring optimal battery life. The wearable wireless multi-component device (205) further comprises a wireless communication chip which transmits the processed data to the data collection hub. The wireless communication chip is based on Bluetooth Low Energy (BLE), modified as per the specialized communication protocol to include synchronization data within the header of data packets. The wearable multi-component device (205) further comprises a compact, embedded antenna integrated as a thin, flexible layer within the casing or strap and designed for effective short-range communication with minimal power consumption. The wearable wireless multi-component device of this example is designed to capture both electromyography (EMG) data, which measures muscle activity, and optional photoplethysmogram (PPG) data, which can measure blood volume changes for applications like heart rate monitoring. The internal electronics of a wearable wireless multi-component device comprises EMG circuitry with amplifiers to magnify the raw EMG signal, an Analog-to-Digital Converter (ADC) for converting the analog EMG signals into digital format and filtering circuits to remove noise and other unwanted signals. The wearable wireless multi-component device (205) further comprises conductive electrodes for capturing EMG signals. The electrodes may be incorporated into the casing, or the attached strap. These electrodes are coated with a hypoallergenic gel to improve signal quality and user comfort.

Sampling frequency of a sensor can vary based on the specific needs of the application. For example, gross movements of a person may be captured at a lower sampling frequency (e.g., 50 Hz), while more intricate motions of a person may require higher frequencies (e.g., 200 Hz). EMG signals require a high sampling frequency, typically around 1000 Hz or more, to accurately capture the electrical activity of muscles. The PPG sensor, if used, may operate at a much lower sampling frequency, usually around 100-200 Hz, since it is often used for measuring slower physiological phenomena like heart rate.

Data preparation in the wearable wireless multi-component device starts from preliminary processing, where filtering and initial processing are performed on the captured data. Then the microcontroller (204, 208) forms a data packet to be sent to the hub. The communication protocol is modified utilizing rarely used header bits by insertion of additional data. In this step, during its regular data transmission synchronization-relevant information is embedded into the header of each data packet as per the modified communication protocol. This embedded information allows for automatic synchronization of wearable wireless multi-component devices without requiring explicit synchronization signals from the data hub. Automatic synchronization of wearable wireless multi-component devices is a critical feature in a multi-sensor environment, particularly when real-time data collection and analysis are involved. A local timestamp generated by each wearable wireless multi-component device itself is often part of the embedded information, capturing the precise moment the sensor reading was taken.

Data reception at data collection hub requires multiple receivers. The data collection hub uses multiple BLE/Wi-Fi receivers to accommodate signals from all connected wearable wireless multi-component devices. As packets arrive, they are temporarily buffered and initially sorted based on their source identifiers and local timestamps.

The synchronization algorithm performs extraction of header information, timestamp mapping, alignment and synchronization. The data collection hub extracts the synchronization-relevant information from each packet's header. A mapping layer converts local wearable wireless multi-component device timestamps to a common time framework. Using the mapped timestamps and header information, the algorithm aligns the data streams from different wearable wireless multi-component device in real-time, eliminating the need for explicit synchronization signals.

Time-series analysis for fine-tuning uses cross-correlation or alternative signal registration algorithm for signals like EMG or motion data. Machine learning models may be deployed to predict and correct minor synchronization issues that might arise due to network latencies or sensor drift.

Real-time data fusion and processing block is responsible to provide unified data stream. After synchronization, a unified data stream is created, aggregating all sensor data into a single, time-aligned dataset. This unified dataset can then be processed immediately for real-time analytics or further cloud-based analysis.

The data collection hub continually monitors key metrics related to synchronization accuracy in monitoring and validation block. In case of any issues that might affect synchronization, alerts can be displayed on the user interface for immediate attention.

The data collection hub is an independent device capable of simultaneous data receipt from multiple wearable wireless multi-component devices, ranging in total from 8 to 32 sensors.

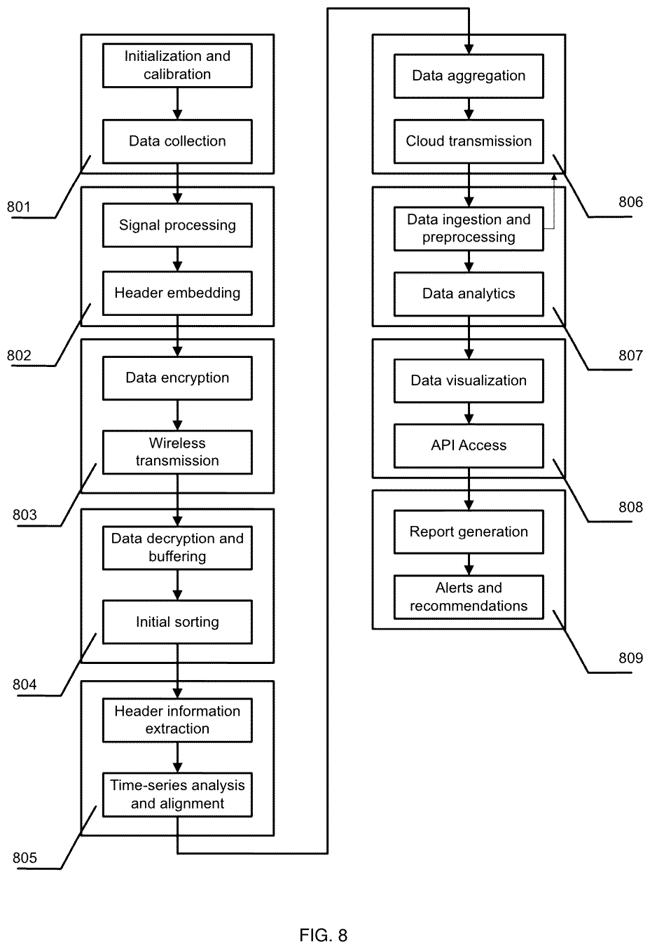

The entire data collection, synchronization, and analysis process, beginning from the moment data is captured by the wearable wireless multi-component devices to the point where processed data is accessed by end users, as shown in FIG. 8, can be divided into several key blocks, which map transfer of data from its collection at the sensors to its final presentation to end users. Sensor data capture (801) performs initialization and calibration, data collection. The wearable wireless multi-component devices initialize and calibrate themselves upon startup or when commanded. Sensors capture relevant signals like EMG, motion, or PPG, at their respective sampling frequencies. Data packet formation (802) performs basic signal processing, such as filtering and normalization. Using the modified communication protocol, synchronization-relevant information and local timestamps are embedded into the data packet headers. Wireless data transmission (803) performs encryption of data packets for secure transmission. Packets are sent wirelessly to the data collection hub. Data collection hub reception (804) performs data decryption and buffering, where data packets are decrypted and buffered temporarily. In initial sorting block packets are initially sorted based on their source identifiers and embedded timestamps. Automatic wearable wireless multi-component device synchronization (805) requires header information extraction, where synchronization-relevant information is extracted from packet headers. The time-series analysis and alignment block include signal registration algorithms like cross-correlation and machine learning models, which are used to fine-tune the synchronization. Data transfer to cloud (806) use data aggregation block, where all synchronized data packets are aggregated into a single dataset. In a cloud transmission block the aggregated dataset is sent to the cloud for further analysis. Cloud-based analysis (807) is performed in two steps. In data ingestion and preprocessing block data undergoes decompression, parsing, and storage. In data analytics block signal analysis algorithms and pattern matching techniques are applied. End-user data access (808) performs data visualization and provides API access. Processed data is visualized in a user-friendly dashboard accessible to patients or other users. Advanced users can programmatically access their processed data via a well-documented API. Reporting and notifications (809) are provided by report generation block, where users can generate downloadable reports in multiple formats. Alerts and recommendations are used for users to receive automatic alerts or recommendations based on processed data.

Each block in the flowchart of FIG. 8 represents a critical stage in the overall pipeline. From the initial data capture by wearable wireless multi-component devices to the complex algorithms run on the cloud-based platform, all the way to the end-user experience, the process is designed for efficient and accurate data handling, synchronization, and analysis. This flowchart serves as a comprehensive overview that illustrates the integrated and automated nature of the system.

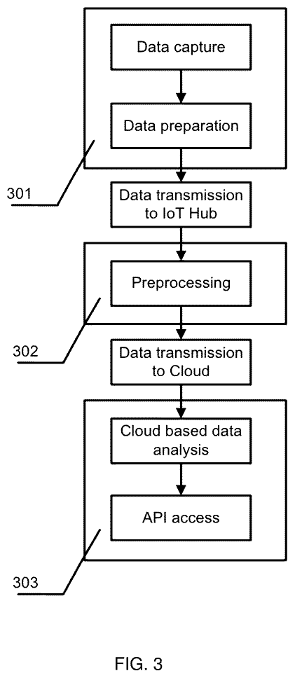

According to the invention and as shown in FIG. 3, the wearable wireless multi-component devices (301) perform two main functions: data capture and data preparation. Data capture starts from initialization, where the microcontroller (204, 208) initializes the system, activates the sensors, and sets the sampling frequencies. The EMG, PPG, and other sensors capture data at their respective sampling frequencies. A temporary buffer in the microcontroller (204) stores this data momentarily before it is transmitted to the data hub.

Data transmission to data collection (IoT) hub block performs wireless (e.g. BLE/Wi-Fi) Transmission of the data. The data packet, now complete with the synchronization-relevant information in its header, is sent via Bluetooth Low Energy (BLE) or Wi-Fi or alternative protocol to the data collection hub. The hub sends back an acknowledgement signal to confirm receipt. Data collection hub performs data aggregation and preprocessing (302). The received data packets are stored in a local database (data storage). Utilizing the synchronization-relevant information from the packet headers, the hub also performs automatic initial synchronization of data from multiple sensors.

After a certain amount of data is collected or at regular intervals, the hub uploads the data to the cloud server. At the Data transfer to cloud stage, the data is encrypted and sent over a secure connection to ensure data integrity and confidentiality.

To provide biological feedback from the collected data, deeper analysis of collected data is performed in the cloud (303). Data analysis comprises: data decompression and parsing; application signal analysis algorithms; pattern matching and motion tracking. Once received in the cloud, the data is decompressed and parsed for further analysis. Algorithms process the EMG and optional PPG data, possibly in conjunction with data from other types of sensors. If motion data is involved, pattern matching techniques may be used for sophisticated motion tracking and analysis.

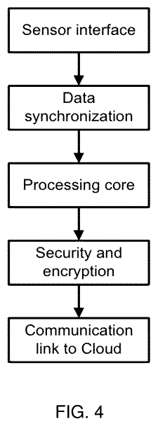

As shown in FIG. 4, the invention also encompasses and is compatible with existing IoT (Internet of Things) smart networks that interfaces smoothly with the main system, multiplying its capabilities and broadening its breadth. IoT allows receiving access to tailored data and insights via a specialized bridges via the cloud, enabling a greater knowledge of the rehabilitation development and performance. Furthermore, IoT integration allows for direct connection between compatible wearable sensors and other IoT enabled smart devices, improving user experience and providing targeted actions or warnings when deviations from prescribed patterns are discovered. The wearable wireless multi-component device interface block contains one or multiple receivers (e.g. Bluetooth Low Energy (BLE) and/or Wi-Fi) to enable the hub to communicate with several wearable sensors simultaneously. A well-designed antenna array ensures optimum signal reception from sensors that may be scattered around in various orientations. A multiplexer is responsible for channelling the incoming data streams to the processing core. Data synchronization block includes time-stamping engine and a synchronization algorithm. Time-stamping engine assigns precise timestamps to incoming data packets based on the synchronization-relevant information embedded in their headers. An internal synchronization algorithm utilizes the timestamps and embedded synchronization-relevant information to align the data from various sensors, ensuring they can be meaningfully compared or combined. At the processing core the central or graphical processing unit performs real-time data processing, including filtering, aggregation, and initial analysis. A fast-access memory buffer temporarily stores incoming and processed data, serving as a bridge between real-time data collection and periodic data transmission to the cloud. A more extensive database (e.g. SSD-based) may be employed for more prolonged data storage, providing a data backup and enabling local analytics. The security and encryption block performs encryption and authentication. Before forwarding to the cloud, data is encrypted to ensure confidentiality and integrity. Authentication handles secure connections, making sure that only authorized sensors can connect and send data to the hub. Communication link to cloud includes usual internet interface. This is generally an Ethernet or Wi-Fi module that allows the hub to connect to the internet. The protocol stack is responsible for the set of networking protocols used for secure and reliable data transmission to the cloud, such as TCP/IP and HTTPS. The additional batch upload engine manages the uploading of data to the cloud, either based on specific time intervals or when a certain amount of data has been collected. Data collection hub may also include user interface and monitoring capabilities implemented as a status LEDs/Display. User input Interface may include buttons or a touchscreen to allow users to interact with the device for tasks like manual synchronization, network settings, or viewing local data.

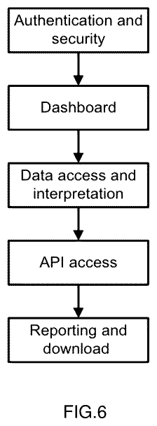

As shown in FIG. 6, the user interface serves as the front-end to the sophisticated cloud-based analysis system. Designed for ease of use and intuitive navigation, the interface provides users—be it patients undergoing rehabilitation, athletes, or parents of kids engaged in activity games—with the tools they need to access, view, and interpret the data captured by the wearable sensors. A secure login page for user authentication, including two-factor authentication options for added security. User profile management implemented in authentication and security block allows users to manage their profiles, including health metrics and preferences. The dashboard includes at-a-glance metrics for immediate presentation of key metrics like heart rate, motion analytics, or rehabilitation progress. Data can be viewed in multiple formats—line graphs, pie charts, or heat maps—to enable easier interpretation. An optional feature of real-time monitoring enables users to see data streaming in real-time, especially useful for live workouts or medical observations. Data access and interpretation block enables users to access historical data, add annotations and tooltips, provide alerts and notifications. Users can sift through historical data, filtering by date, type of activity, or specific health metrics. Annotations are used for hovering over or selecting data points reveals additional information and interpretations, aiding in better understanding. Optionally automated pop-ups or messages that indicate significant changes or milestones in the data could be added to the system. API access is used to access user data programmatically through the API. Reporting and download options block give an opportunity for users to generate and download detailed reports in PDF, CSV, or other formats. These reports contain not just data tables but also visual elements like graphs and charts for better understanding. Each report includes an easy-to-read summary section that breaks down key findings and provides actionable recommendations. By leveraging a comprehensive set of tools and features, the user interface ensures that a wide range of users can effortlessly access, view, and interpret their data. The added ability to programmatically access data through a well-documented API opens the door to more customized and advanced use-cases, empowering users to make informed decisions based on their health and activity metrics. In one instance, the method comprises cloud-based analysis comprising pattern matching for motion synchronization pattern matching algorithms. The algorithms are such as dynamic time warping (DTW) for synchronizing motion data across sensors. This ensures that even if two sensors start capturing data at slightly different times, their outputs can be temporally aligned based on the patterns detected, facilitating accurate motion tracking.

The cloud-based analysis system is the cornerstone for transforming raw sensor data into actionable insights. Housed on a distributed computing infrastructure, it is engineered for scalability, reliability, and high-speed data processing.

Data ingestion and preprocessing block performs data decompression, data parsing and formatting. The first step in the pipeline is the decompression of data batches received from the Data collection hub. Additional module parses the incoming data into structured formats like JSON or XML for easier handling. The parsed data is stored in scalable, distributed databases like NoSQL or time-series databases, optimized for high-velocity data at the data storage block.

Signal analysis algorithms are used for medical signal analysis. EMG signal analysis algorithms may include Fourier transform to convert time-domain signals into the frequency domain for spectral analysis. Statistical features like mean, variance, and kurtosis can be also extracted. Machine learning techniques, such as convolutional neural networks, could also be used for feature extraction. PPG signal analysis algorithms (if applicable) may include algorithms for peak detection, which identifies peaks to calculate heart rate or other cardiovascular metrics, noise reduction algorithms to filter out high-frequency noise and artifacts for cleaner signals.

In cases where data from multiple types of sensors need to be integrated, advanced fusion algorithms combine these different data streams into a single, unified dataset.

Pattern matching and motion tracking can be performed using dynamic time warping (DTW). For motion sensors, DTW algorithms align sequences of sensor data that are temporally shifted. Machine learning classifiers, such as Support Vector Machines or Random Forest algorithms may be used to classify specific motion patterns or anomalies.

Data analytics engine uses advanced analytics algorithms. Additional machine learning or statistical models may be applied to the processed data for deeper insights or predictions. The pipeline may also include temporal analysis algorithms, which analyses the change of features and patterns over time for longitudinal studies.

A simple reporting engine ensures that the processed data and analytics results are displayed in an intuitive, user-friendly dashboard. Automatic triggers or alerts based on specific conditions or thresholds could be used in conjunction to biological feedback provided by a graphical user interface.

API layer allows secure, programmatic access to processed data and analytics results. Integration API facilitates the integration with other platforms or electronic health record (EHR) systems (if applicable).

In another instance the method comprises API-driven data access offering RESTful APIs, enabling easy integration with third-party applications. Such APIs would support data retrieval, analytics configurations, and real-time streaming.

The system according to the invention can be used in home-based rehabilitation for patients recovering post-surgery. Here, the sensors guide patients in performing specific exercises, ensuring correct postures and movement patterns. The cloud platform preferably has pre-loaded exercise regimes, which are then customized for each patient based on their progress.

In another instance the system according to the invention can be used for fitness and gaming. Here, motion sensors provide feedback on exercise routines, while gaming applications use sensor data to make games more interactive and physically engaging.

The method for automatic synchronization of wearable wireless multi-component devices in the system according to the invention comprises the steps of:
capturing data from multiple sensors;
transmitting the data to a collection hub using a modified protocol that integrates synchronization information into the header of data packets;
forwarding the data to a cloud-based processing platform;
analysing and synchronizing the data using said platform;
providing access to the synchronized data through an API interface.

The step of analysing and synchronizing the data involves the use of pattern matching techniques to ensure the precision of motion tracking.

The synchronization process negates the need for explicit synchronization signals from the data collection hub, ensuring a seamless and efficient data collection and processing workflow.

The results of the cloud-based signal processing are accessible and reviewable via an API, enabling third-party integrations and user-friendly data interpretation interfaces.

1. A system for collecting and synchronizing data from multiple wearable wireless multi-component devices comprising:
multiple sensors capable of recording medical signals and motion;
a data collection hub designed to receive data from the sensors;
a cloud-based signal processing platform to analyse said data;
a modified communication protocol which integrates synchronization information into the header of data packets without the need for explicit synchronization signals.

2. The system of claim 1, wherein the wearable wireless multi-component devices operate at various sampling frequencies based on the nature of data they are designed to capture.

3. The system of claim 1, wherein the wearable wireless multi-component devices comprise both medical signal sensors and motion sensors, with each designed to function optimally for specific user activities including rehabilitation procedures, workouts, and children's games.

4. The system of claim 1, wherein the data collection hub is an independent device capable of simultaneous data receipt from multiple wearable wireless multi-component devices, in total ranging from 8 to 32 sensors.

5. The system of claim 1, wherein the cloud-based signal processing platform employs pattern matching techniques to synchronize motion data across various sensors, facilitating accurate motion tracking.

6. The system of claim 1, wherein the modified communication protocol is built upon a foundational pre-existing protocol, integrating additional synchronization-relevant information into the header of data packets.

7. A method for automatic synchronization of wearable wireless multi-component device in the system of claim 1, comprising the steps of:
capturing data from multiple sensors;
transmitting the data to a collection hub using a modified protocol that integrates synchronization information into the header of data packets;
forwarding the data to a cloud-based processing platform;
analysing and synchronizing the data using said platform;
providing access to the synchronized data through an API interface.

8. The method of claim 7, wherein the step of analysing and synchronizing the data involves the use of pattern matching techniques to ensure the precision of motion tracking.

9. The method of claim 7, wherein the synchronization process negates the need for explicit synchronization signals from the data collection hub, ensuring a seamless and efficient data collection and processing workflow.

10. The system of claim 1, wherein the results of the cloud-based signal processing are accessible and reviewable via an API, enabling third-party integrations and user-friendly data interpretation interfaces.
